(19) United States
(12) Patent Application Publication
(10) Pub. No.: US 2024/0006970 A1
(43) Pub. Date: Jan. 4, 2024

(54) DOUBLE AIR GAP-TYPE SURFACE PERMANENT MAGNET SYNCHRONOUS MOTOR PROVIDED WITH DOUBLE CONTROLLERS

(71) Applicant: KYUNGSUNG UNIV. INDUSTRY COOPERATION FOUNDATION, Busan (KR)

(72) Inventors: Jin-woo AHN, Busan (KR); Kwang-il JEONG, Jinju-si Gyeongsangnam-do (KR); Do-hyun KANG, Changwon-si Gyeongsangnam-do (KR)

(21) Appl. No.: 18/039,250

(22) PCT Filed: Jan. 20, 2021
(86) PCT No.: PCT/KR2021/000797

§ 371 Date: May 28, 2023

(30) Foreign Application Priority Data
Nov. 27, 2020 (KR) 10-2020-0162511

(51) Int. Cl. H02K 16/00; H02K 11/30; H02K 1/278; H02K 21/12; H02K 11/01

(52) U.S. Cl. CPC H02K 16/00; H02K 11/30; H02K 1/278; H02K 21/12; H02K 11/012

(57) ABSTRACT

The present disclosure relates to a double air gap surface permanent magnet synchronous motor with two controllers, and particularly, to a double air gap surface permanent magnet synchronous motor with two controllers, which doubles structures of a rotor and a stator to improve torque performance and has high efficiency and a high power density that satisfy an international efficiency class IE5 of International Electro-technical Commission (IEC) and solves failures by including individual controllers. According to an embodiment the present disclosure, a double air gap surface permanent magnet synchronous motor with two controllers, includes a first stator including first protrusions formed on a first inner circumferential surface, a first rotor including a first outer circumferential surface facing the first inner circumferential surface, first permanent magnets arranged on the first outer circumferential surface, a second rotor integrally connected to the first rotor to correspond to an inside of the first rotor and including a second inner circumferential surface, second permanent magnets arranged on the second inner circumferential surface, a second stator including second protrusions formed on a second outer circumferential surface formed to face the second inner circumferential surface, a partition wall portion formed at a boundary between the first rotor and the second rotor, a first controller for controlling a first winding wire wound around the first protrusions, and a second controller for controlling a second winding wire wound around the second protrusions.

### TECHNICAL FIELD

The present disclosure relates to a double air gap surface permanent magnet synchronous motor with two controllers, and particularly, to a double air gap surface permanent magnet synchronous motor with two controllers, which doubles structures of a rotor and a stator to improve torque performance and has high efficiency and a high power density that satisfy an international efficiency class IE5 of International Electro-technical Commission (IEC) and solves failures by including individual controllers.

### BACKGROUND OF INVENTION

In general, a motor is a device that converts electrical energy into mechanical energy to obtain rotational power and is widely used not only in home electronic products but also in industrial equipment and is largely divided into a direct current (DC) motor and an alternating current (AC) motor.

That is, AC-DC motors are widely used in various industries as a production process is automated and becomes highly precise in order to improve productivity.

A surface permanent magnet synchronous motor (SPMSM) includes a rotor made of permanent magnets and a stator consisting of an armature with a winding wire wound around a core and is classified as an SPMSM if a shape of a back electromotive force (EMF) generated when the motor rotates is a sine wave and is classified as a brushless direct current (BLDC) if the shape of the back EMF is a rectangular wave.

In addition, the motor is divided into an interior permanent magnet (IPM) motor in which permanent magnets are buried in a rotor core according to an arrangement of the permanent magnets in a rotor, and a surface permanent magnet (SPM) motor in which the permanent magnets are arranged on a surface of the rotor core.

A conventional SPM motor will be described with reference to the accompanying drawings.

FIG. 1 is a plan view illustrating an SPM motor according to the conventional art.

As illustrated in FIG. 1, in a conventional SPM motor 10, a rotor 13 is installed to be rotatable by a shaft 14 with an air gap inside a stator 12 on which a coil (not shown) is wound, and a plurality of permanent magnets 15 are arranged on and fixed onto an outer circumferential surface of the rotor 13.

The stator 12 includes a plurality of teeth 12b protruding at regular intervals on an inner circumferential surface of a yoke portion 12a having a circular ring shape, and a coil (not illustrated) is wound for each tooth 12b to be fixed to a housing (not illustrated) of the motor 10.

The rotor 13 is manufactured by stacking a plurality of silicon steel sheets, a shaft hole 13a is formed in the center to be fixed through the shaft 14, a magnet mounting groove 13b is formed along a circumference of an outer circumferential surface, and permanent magnets 15 are inserted and fixed by pressing for each magnet mounting groove 13b.

When AC power is applied to a coil (not illustrated), a magnetic flux is generated in a direction perpendicular to the shaft 14 to rotate the conventional SPM motor 10, this rotational magnetic flux generates a torque in the rotor 13 due to a magnetic flux of the permanent magnets 15 on a surface of the rotor 13, thereby rotating the rotor 13.

Meanwhile, as a climate change due to excessive greenhouse gas emission is serious, a paradigm of energy policy is rapidly shifting by focusing on energy demand management, such as energy saving and improvement of utilization efficiency to reduce the greenhouse gas emission.

A motor accounts for more than 54% of the total power consumption.

With the development of core technology of the motor, increases in performance such as miniaturization, light weight, low noise, low vibration, and high efficiency of the motor are steadily being made, and an increase in efficiency is continuously required as effective means for saving energy and reducing greenhouse gas emissions according to a new climate agreement.

FIG. 2 illustrates an international efficiency class of the International Electro-technical Commission (IEC), and there is an urgent need for an SPM motor that may satisfy a class IE5 by improving the conventional technology.

### DETAILED DESCRIPTION

### Problems to be Solved

An object of an embodiment of the present disclosure is to provide a double air gap surface permanent magnet synchronous motor with two controllers that may double structures of a rotor and a stator to improve torque performance and may have high efficiency and a high power density that satisfy an international efficiency class IE5 of International Electro-technical Commission (IEC) and may achieve safety by using two controllers.

### SUMMARY OF INVENTION

According to an embodiment of the present disclosure, a double air gap surface permanent magnet synchronous motor with two controllers, includes a first stator configured to include first protrusions formed on a first inner circumferential surface, a first rotor configured to include a first outer circumferential surface facing the first inner circumferential surface, first permanent magnets arranged on the first outer circumferential surface, a second rotor integrally connected to the first rotor to correspond to an inside of the first rotor and configured to include a second inner circumferential surface, second permanent magnets arranged on the second inner circumferential surface, a second stator configured to include second protrusions formed on a second outer circumferential surface formed to face the second inner circumferential surface, a partition wall portion formed at a boundary between the first rotor and the second rotor, a first controller for controlling a first winding wire wound around the first protrusions, and a second controller for controlling a second winding wire wound around the second protrusions.

### Advantages of Invention

According to the present disclosure, a high power density and a high torque may be obtained by including a double air gap structure.

In addition, a cogging torque may be reduced more than in the past by the double air gap structure.

In addition, efficiency may be increased by improving a material of the double air gap structure under the same conditions.

In addition, two controllers are provided and even when one of the two controllers fails, the other controller may perform control.

### BRIEF DESCRIPTION OF DRAWINGS

FIG. 1 is a view illustrating a surface-attached magnetic motor according to the conventional art.

FIG. 2 is a diagram illustrating an international efficiency class of International Electrotechnical Commission (IEC).

FIG. 3 is an exemplary cross-sectional view illustrating a conventional surface permanent magnet synchronous motor (SPMSM) and a proposed double air gap SPMSM.

FIG. 4 is a graph illustrating a back electromotive force of the conventional SPMSM and the proposed double air gap SPMSM.

FIG. 5 is a graph illustrating cogging torques of the conventional SPMSM and the proposed double air gap SPMSM.

FIG. 6 is a graph illustrating core losses (iron losses) of the conventional SPMSM and the proposed double air gap SPMSM.

FIG. 7 illustrates graphs of magnetic flux densities of the conventional SPMSM and the proposed double air gap SPMSM.

FIG. 8 is a graph illustrating losses of permanent magnet of the conventional SPMSM and the proposed double air gap SPMSM.

FIG. 9 is a graph illustrating torque of the conventional SPMSM and the proposed double air gap SPMSM.

FIG. 10 is a diagram illustrating a specification of a conventional SPMSM(I).

FIG. 11 is a graph illustrating result values of the conventional SPMSM(I).

FIG. 12 is a diagram illustrating a specification of a conventional SPMSM(II).

FIG. 13 is a graph illustrating result values of the conventional SPMSM(II).

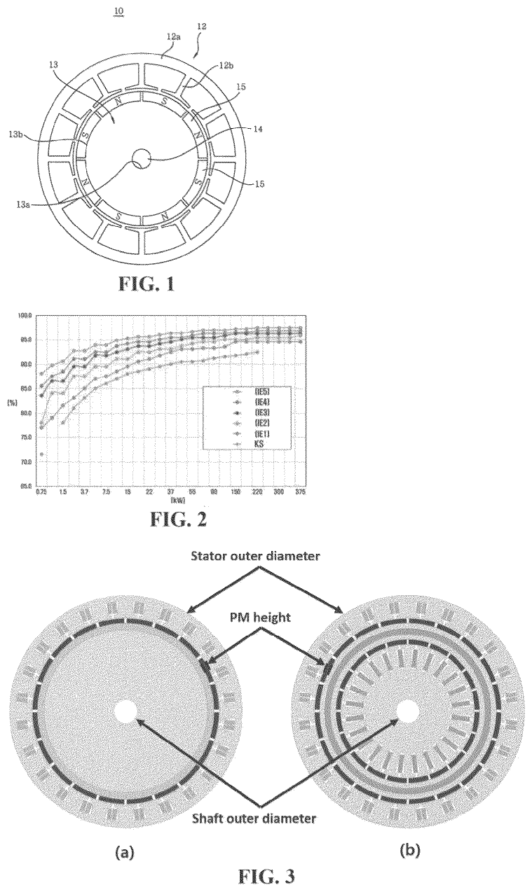

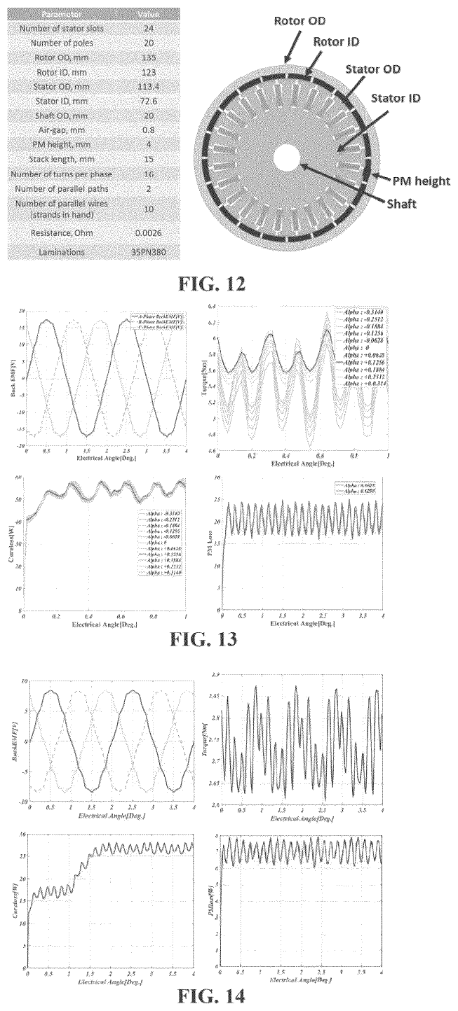

FIG. 12 is a diagram illustrating specifications of the conventional SPMSM(II) and a conventional SPMSM(III).

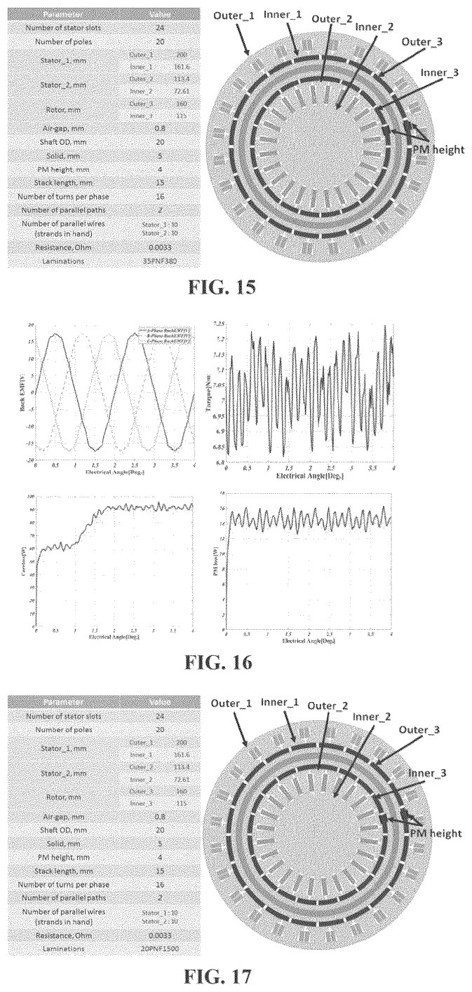

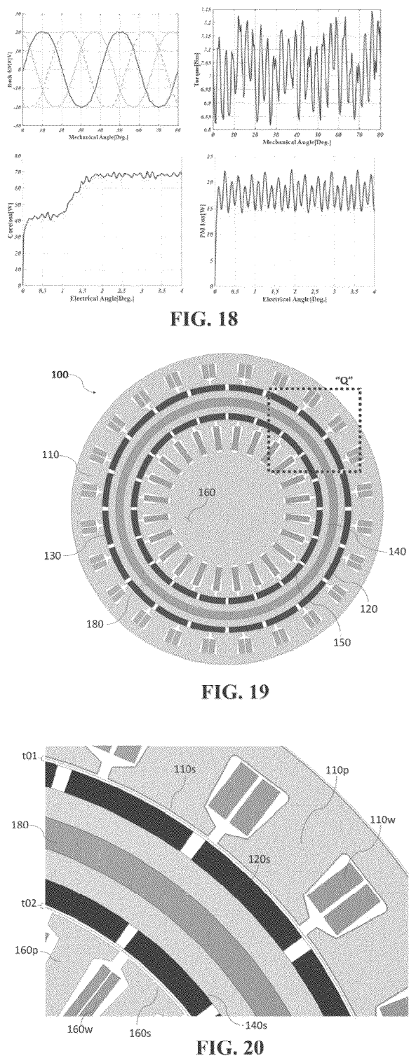

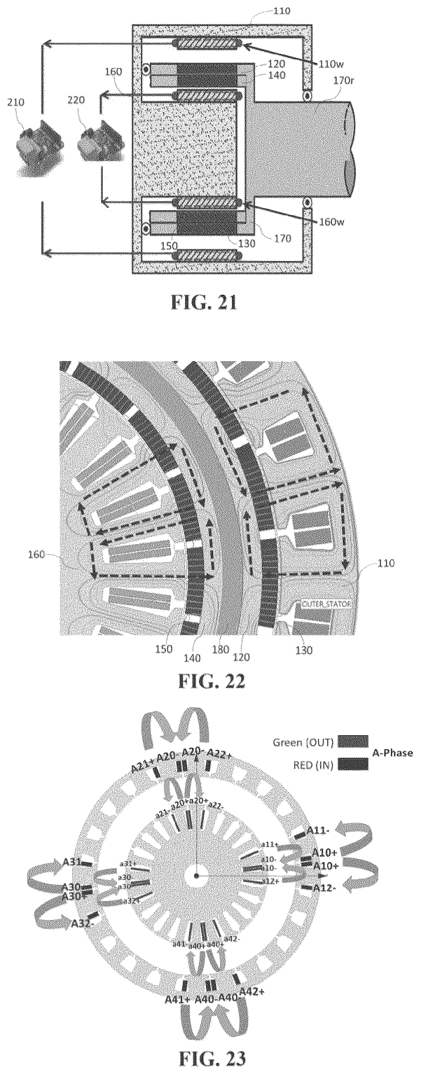

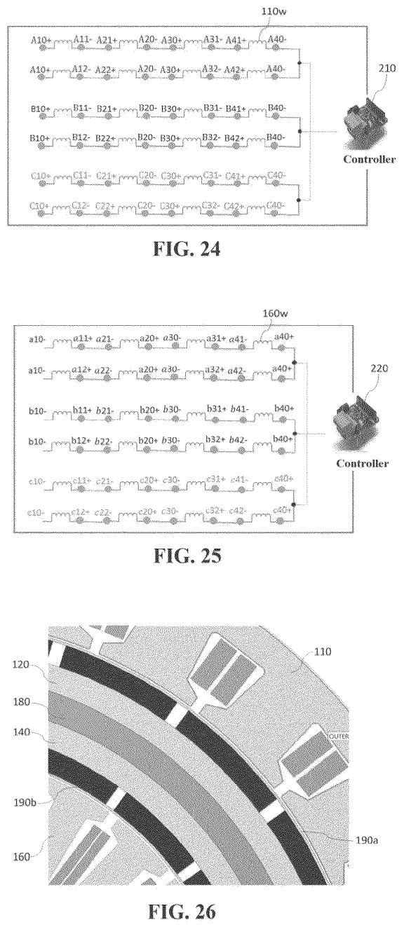

FIG. 13 is a graph illustrating result values of the conventional SPMSM(II).

FIG. 14 is a graph illustrating result values of the conventional SPMSM(III).

FIG. 15 is a diagram illustrating a specification of a proposed double air gap SPMSM(IV).

FIG. 16 is a graph illustrating result values of the proposed double air gap SPMSM(IV).

FIG. 17 is a diagram illustrating a specification of a proposed double air gap SPMSM(V).

FIG. 18 is a graph illustrating result values of the proposed double air gap SPMSM(V).

FIG. 19 is an exemplary cross-sectional view illustrating a double air gap SPMSM with two controllers, according to an embodiment of the present disclosure.

FIG. 20 is an enlarged view of a portion “Q” of FIG. 19.

FIG. 21 is an exemplary longitudinal sectional view illustrating the double air gap SPMSM including the two controllers, according to an embodiment of the present disclosure.

FIG. 22 is a diagram illustrating a magnetic flux direction illustrating the double air gap SPMSM with two controllers, according to an embodiment of the present disclosure.

FIG. 23 is an exemplary view illustrating a winding direction for a phase for an A phase of three phases for explaining the double air gap SPMSM with two controllers, according to an embodiment of the present disclosure.

FIGS. 24 and 25 are circuit diagrams illustrating the double air gap SPMSM with two controllers, according to an embodiment of the present disclosure.

FIG. 26 is an exemplary view illustrating a partition wall portion of a double air gap SPMSM with two controllers, according to an embodiment of the present disclosure.

### EMBODIMENTS

Hereinafter, Hereinafter, embodiments of the present disclosure will be described in detail with reference to the accompanying drawings such that those of ordinary skill in the art may easily implement the present disclosure. However, the present disclosure may be implemented in various forms and is not limited to the embodiments described herein.

The terminology used herein is only for referring to specific embodiments and is not intended to limit the present disclosure. Singular forms used herein also include plural forms unless the phrases clearly indicate the opposite. The meaning of “including” used in the specification specifies a specific characteristic, a region, an integer, a step, an operation, an element, and/or a component, and does not exclude other specific characteristics, regions, integers, steps, operations, elements, components, and/or existence or addition of a group.

Although not defined differently, all terms including technical and scientific terms used herein have the same meaning as commonly understood by one of ordinary skill in the art to which the present disclosure belongs. Terms defined in a commonly used dictionary are additionally interpreted as having a meaning consistent with the related technical literature and the presently disclosed content and are not interpreted in an ideal or very formal meaning unless defined.

Embodiments of the present disclosure described with reference to the drawings specifically represent ideal embodiments of the present disclosure. As a result, various variations of the illustration are expected, for example variations in manufacturing methods and/or specifications. Accordingly, the embodiments are not limited to a specific shape of the illustrated portion, and include, for example, a modification of the shape according to manufacturing. Portions illustrated or described as being flat may have generally coarse and non-linear characteristics.

In addition, portions illustrated as having a sharp angle may be rounded. Accordingly, the portions illustrated in the drawings are originally only approximate, and their shapes are not intended to illustrate exact shapes of the portions and are not intended to narrow the scope of the present disclosure.

Note that the drawings are schematic and have not been drawn to scale. Relative dimensions and ratios of portions in the drawings are exaggerated or reduced in size for the sake of clarity and convenience in the drawings, and any dimensions are merely exemplary and not limiting. In addition, the same reference numerals are used for the same structure, element, or component illustrated in two or more drawings to correspond or indicate similar features in different embodiments.

Because it is required to constantly increase efficiency of a motor that is an effective apparatus for reducing consumption of greenhouse gas and consumes more than 54% of power, the present disclosure proposes a design of a double air gap type surface permanent magnet synchronous motor (SPMSM) with high efficiency and a high-power density that satisfies an international efficiency class IE5 of International Electro-technical Commission (IEC).

A conventional SPMSM has an inter rotor type structure or an outer rotor type structure in which a rotor is outside or inside the SPMSM as illustrated in (a) of FIG. 3.

A structure proposed by the present disclosure has a double air gap structure using a rotor yoke illustrated in (b) of FIG. 3 modified from an inter rotor type structure of the conventional SPMSM illustrated in (a) of FIG. 3 in order to increase efficiency and a power density.

Characteristics of the conventional structure and the proposed structure of the present disclosure were analyzed through finite elements method (FEM), and results thereof are compared as follows.

Introduction

As a change in climate due to excessive greenhouse gas emissions emerges seriously, a paradigm of energy policy is rapidly shifting by focusing on energy demand management such as energy saving to reduce greenhouse gas emissions and an increase in efficiency of use.

A motor accounts for more than 54% of the total power consumption.

With the development of core technology of a motor, increases in performance such as miniaturization, light weight, low noise, low vibration, and high efficiency of the motor are steadily being made, and an increase in efficiency is continuously required as effective means for saving energy and reducing greenhouse gas emissions according to a new climate agreement.

FIG. 2 illustrates an international efficiency class of the International Electro-technical Commission (IEC), and the present disclosure is proposed by designing a double air gap type SPMSM to satisfy the IE5 class.

According to the present disclosure, efficiency and a power density of the conventional structure and the proposed structure were analyzed for characteristics based on the FEM, and performance is compared.

Body

2.1 Structures and Characteristic Analysis of Conventional SPMSM and Proposed SPMSM

In a case of a conventional SPMSM and a proposed SPMSM, an outer diameter of a stator and a stacking length are the same, and detailed design structures of each are shown in Table 1.

TABLE 1

| Parameter | Value | Unit |
|---|---|---|
| Number of stator slots | 24 | slot |
| Number of poles | 20 | pole |
| Stator outer diameter | 200 | mm |
| Shaft outer diameter | 20 | mm |
| Air gap | 0.8 | mm |
| PM height | 4 | mm |
| Stack length | 15 | mm |
| Number of turns per phase | 16 | turn |
| Number of parallel paths | 2 | path |
| Number of parallel wires | 10 | turn |
| (strands in hand) | | |

FIG. 3 illustrates structures of a conventional SPMSM and a proposed SPMSM including 24 slots and 20 poles.

In a case of materials of a conventional structure and a proposed structure, 35PN380 of POSCO′ was applied and is compared.

In addition, in a case of the proposed structure, an additional 20PN1500 was applied, and characteristics of a material 35PN380 of the conventional SPMSM and materials 35PN380 and 20PN1500 of the proposed SPMSM were analyzed and are compared with each other.

For reference, 35PN380 is a non-oriented electrical steel sheet manufactured by a company (POSCO) and has a standard dimension, a magnetic property, and so on with a thickness of 0.35±0.05 mm, a density of 7.65±0.1 kg/cm², a core loss of 3.80 W/kg or less, a magnetic flux density of 1.62 or more, and a conductor-occupying ratio of 95% or more.

In addition, 20PN1500 is a non-oriented electrical steel sheet manufactured by the company (POSCO) and has a standard dimension, magnetic property, and so on with a thickness of 0.20±0.05 mm, a density of 7.65±0.1 kg/cm², a core loss of 15.0 W/kg or less, a magnetic flux density of 1.62 or more, and a conductor-occupying ratio of 93% or more.

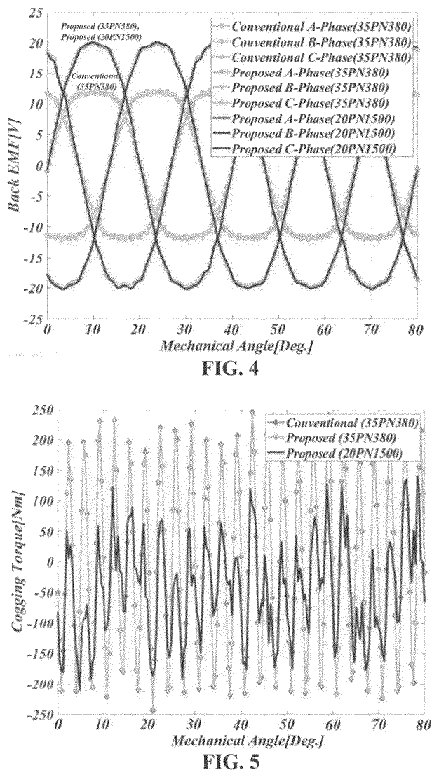

FIG. 4 is a diagram illustrating back electromotive forces (EMFs) of the conventional SPMSM and a proposed SPMSM, and a maximum voltage of 35PN380 of the conventional SPMSM is 12.01 V, and a maximum voltage of 20PN1500 of the proposed SPMSM is 20.32 V.

FIG. 5 illustrates cogging torques of the conventional SPMSM and the proposed SPMSM.

In a case of the conventional SPMSM, the cogging torque is 145.68 mNm, and in a case of the SPMSM proposed by the present disclosure, 102.37 mNm when the material is 35PN380, and 93.4 mNm when the material is 20PN1500.

When compared with the conventional SPMSM, a cogging torque of the material 35PN380 of the proposed SPMSM is reduced by 29.7%, and a cogging torque of the material 20PN1500 of the proposed SPMSM is reduced by 35.9%.

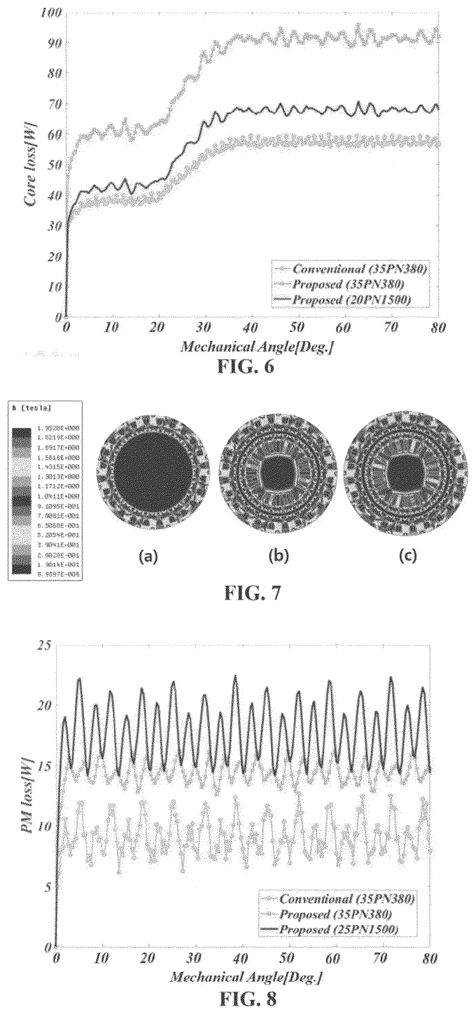

FIG. 6 illustrates core losses of the conventional SPMSM and of the proposed SPMSM.

The conventional SPMSM has a core loss of 51.52 W, the material 35PN380 proposed by the present disclosure has a core loss of 91.4 W, and the material 20PN1500 proposed by the present disclosure has a core loss of 67.8 W.

When compared with the conventional SPMSM, a core loss of the material 35PN380 of the proposed SPMSM is increased by 43.6% and a core loss of the material 20PN1500 thereof is increased by 24.01%.

As illustrated in FIG. 7, it is determined that a core loss increases to a high saturation of a magnetic flux density of a core loss due to an increased winding wire (see (a) and (b) of FIG. 7) more than the conventional SPMSM (see (a) of FIG. 7).

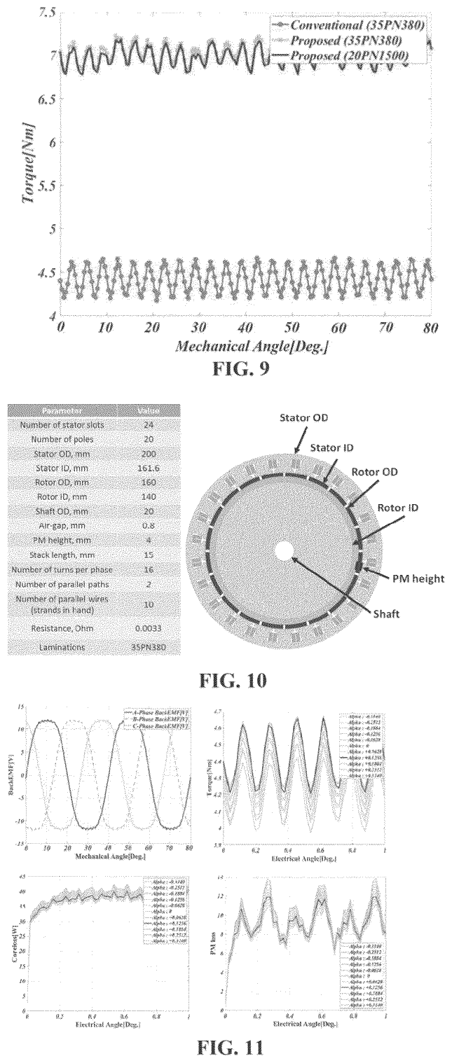

FIG. 8 illustrates losses of permanent magnet of the conventional SPMSM and the proposed SPMSM.

The conventional SPMSM has a loss of permanent magnet of 9.14 W, the material 35PN380 of the proposed SPMSM has a loss of permanent magnet of 14.4 W, and the material 20PN1500 thereof has a loss of permanent magnet of 17.78 W.

The proposed SPMSM is determined to have an increased loss of permanent magnet due to the permanent magnet having a loss of permanent magnet increased by 1.7 times the conventional SPMSM.

In the proposed SPMSM, the loss of permanent magnet of the material 20PN1500 is increased more than the loss of permanent magnet of the material 35PN380.

This is a result of the increased burden on the permanent magnet due to a low saturation level of a magnetic flux density of an iron core.

FIG. 9 illustrates rated torques of the conventional SPMSM and the proposed SPMSM.

The rated torque of the conventional SPMSM is 4.42 Nm.

When compared with the conventional SPMSM, a rated torque of the material 35PN380 of the proposed SPMSM is increased by 37% to 7.02 Nm, and a rated torque of the material 20PN1500 thereof is increased by 36.67% to 6.98 Nm.

Table 2 indicates a performance comparison table of the conventional SPMSM and the proposed SPMSM.

TABLE 2

| | Conventional | Proposed | Proposed |
|---|---|---|---|
| Parameter | (35PN380) | (35PN380) | (20PN1500) |
| Stator current frequency, Hz | 500 | ← | ← |
| Rotor speed, rpm | 3,000 | ← | ← |
| Electromagnetic torque, Nm | 4.42 | 7.02 | 6.98 |
| Output power, W | 1301.96 | 2058.35 | 2066.24 |
| Input, power, W | 1413.33 | 2249.65 | 2237.08 |
| Efficiency, % | 92.12 | 91.45 | 94.23 |
| Wingding losses, W | 24.7 | 44.25 | 44.25 |
| Core losses, W | 51.52 | 91.4 | 67.8 |
| Losses in PMs, W | 9.14 | 14.4 | 17.78 |
| Mechanical losses, W | 25.96 | 41.24 | 41.01 |
| Stator current density, A/mm² | 4.818 | 9.636 | 9.636 |
| Mass of Cu, kg | 0.4421 | 0.7032 | 0.7032 |
| Mass of Fe, kg | 0.1958 | 4.2376 | 4.2376 |
| Mass of PM, kg | 0.1958 | 0.4945 | 0.4945 |
| Total mass, kg | 4.4036 | 5.4353 | 5.4353 |
| Power density, kW/kg | 0.2956 | 0.3787 | 0.3801 |

The conventional SPMSM has a loss lower than the proposed structure because a core loss thereof is 51.52 W, a loss of permanent magnet thereof is 9.14 W, and a mechanical loss thereof is 25.96 W, and has a power density lower than the proposed structure because the power density is 0.2956 kW/kg.

The material 35PN380 of the proposed SPMSM has the power density of 0.3801 kW/kg which is higher than the conventional SPMSM but has a core loss of 91.4 W, the loss of permanent magnet of 14.4 W, and the mechanical loss of 41.24 W due to a double stator structure, which has efficiency of 91.45%, that is slightly lower than the conventional SPMSM by 0.72%, and thus, similar efficiency is obtained.

The material 20PN1500 of the proposed SPMSM has a core loss of 67.8%, which is greater than the core loss of the conventional SPMSM but has an output of 2066.24 W which is the same output as the material 35PN380, and thus, an output is increased by 37% when compared with the conventional SPMSM.

In addition, efficiency of the material 20PN1500 of the proposed SPMSM is increased to 94.23% by 2.23%, and a power density thereof is increased to 0.3801 kW/kg by 22.23%.

In more detail, as illustrated in FIG. 10, a conventional SPMSM(I) of an inter rotor type including a rotor having permanent magnets facing an inner circumference of a stator is as follows.

TABLE 3

| SPMSM(I) Parameter | Value |
|---|---|
| Stator current frequency, Hz | 500 |
| Rotor speed, rpm | 3,000 |
| Shaft torque, Nm | 4.14 |
| Electromagnetic torque, Nm | 4.42 |
| Shaft power(Output Power), | 1301.96 |
| W | |
| Input electric power, W | (2π × (3000/60) × 4.42) + (50 × 50 × |
| | 0.0033 × 3) |
| | 1413.33 |
| Efficiency, % | (1301.96/1413.33) × 100 |
| | 92.12 |
| Winding losses, W | (50 × 50 × 0.0033 × 3) |
| | 24.75 |
| Core losses, W | 51.52 |
| Losses in PMs, W | 9.14 |
| Mechanical losses, W | 25.96 |
| Stator current, A rms | 50 |
| Stator current density, A/mm² | (50/2)/(0.4064 × 0.4064 × 3.14) × 10 = |
| | 4.818 |
| | 4.818 |
| Mass of Cu, kg | 0.4421 |
| Mass of Fe, kg | (Stator_Fe(1.7886) + Rotor_Fe(1.9771)) |
| | 2.0937 |
| Mass of PM, kg | 0.1958 |
| Total mass(Eim components), | 4.4036 |
| kg | |
| Power density, kW/kg | (1.30196/4.4036) |
| | 0.2956 |

FIG. 10 illustrates a structure of a conventional SPMSM(I) including 24 slots and 20 poles.

In addition, a material of the conventional SPMSM(I) is 35PN380.

For reference, 35PN380 is a non-oriented electrical steel sheet manufactured by a company (POSCO) and has a standard dimension, a magnetic property, and so on with a thickness of 0.35 mm, a density of 7.65 kg/cm², a core loss of 3.80 W/kg or less, a magnetic flux density of 1.62 or more, and a conductor-occupying ratio of 95% or more.

FIG. 11 illustrates a back EMF, a core loss, a loss of permanent magnet, and a rated torque of the conventional SPMSM(I).

In addition, the conventional SPMSM(I) has a maximum voltage of back EMF of 12.01 V, a core loss of 51.52 W, a loss of permanent magnet of 9.14 W, a cogging torque of 145.68 mNm, and a rated torque of 4.42 Nm.

In addition, the conventional SPMSM(I) has similar or lower results in a material 20PN1500.

Next, as illustrated in FIG. 12, a conventional SPMSM(II) of an outer rotor type including a rotor having permanent magnets facing an outer circumference of a stator is as follows.

The conventional SPMSM(II) is formed in a direction from which a winding wire goes out, that is, a direction in which torque collision occurs.

TABLE 4

| SPMSM(II) Parameter | Value |
|---|---|
| Stator current frequency, Hz | 500 |
| Rotor speed, rpm | 3,000 |
| Shaft torque, Nm | 5.27 |
| Electromagnetic torque, Nm | 5.69 |
| Shaft power (output power), | 1656.49 |
| W | |
| Input electric power, W | (2π × (3000/60) × 5.69) + (50 × |
| | 50 × 0.0026 × 3) |
| | 1,807.06 |
| Efficiency, % | (1,656.49/1,807.06) × 100% |
| | 91.66 |
| Winding losses, W | (50 × 50 × 0.0026) × 3 |
| | 19.5 |
| Core losses, W | 77.78 |
| Losses in PMs, W | 19.87 |
| Mechanical losses, W | 33.42 |
| Stator current, A rms | 50 |
| Stator current density, A/mm² | (50/2)/(0.4064 × 0.4064 × 3.14) × 10 = |
| | 4.818 |
| | 4.818 |
| Mass of Cu, kg | 0.2611 |
| Mass of Fe, kg | (Stator_Fe(1.6047) + Rotor_Fe(0.5392)) |
| | 2.1439 |
| Mass of PM, kg | 0.2987 |
| Total mass (Eim components), | 2.7037 |
| kg | |
| Power density, kW/kg | (1.65649/2.7037) |
| | 0.6126 |

FIG. 12 illustrates a structure of a conventional SPMSM(II) including 24 slots and 20 poles.

In addition, a material of the conventional SPMSM(II) is 35PN380.

FIG. 13 illustrated a back EMF, a core loss, a loss of permanent magnet, and a rated torque of the conventional SPMSM(II).

In addition, the conventional SPMSM(II) has a maximum voltage of a back electromotive force of 17.01 V, a core loss of 77.78 W, a loss of permanent magnet of 19.87 W, and so on, and a rated torque is 5.69 Nm but is offset because actual collision with a magnetic flux.

In addition, the conventional SPMSM(II) has similar or lower results even in the material 20PN1500.

Next, a conventional SPMSM(III) of an outer rotor type including a rotor having permanent magnets facing an outer circumference of a stator is as follows.

The conventional SPMSM(III) is formed in a direction into which a winding wire goes.

TABLE 5

| SPMSM(III) Parameter | Value |
|---|---|
| Stator current frequency, Hz | 500 |
| Rotor speed, rpm | 3,000 |
| Shaft torque, Nm | 2.6 |
| Electromagnetic torque, Nm | 2.73 |
| Shaft power (output power), | 817.75 |
| W | |
| Input electric power, W | (2π × (3000/60) × 2.73) + (50 × 50 × |
| | 0.0026 × 3) |
| | 877.15 |
| Efficiency, % | (817.75/877.15) × 100% |
| | 93.22 |
| Winding losses, W | (50 × 50 × 0.0026) × 3 |
| | 19.5 |
| Core losses, W | 26.55 |
| Losses in PMs, W | 6.97 |
| Mechanical losses, W | 16.4 |
| Stator current, A rms | 50 |
| Stator current density, A/mm² | (50/2)/(0.4064 × 0.4064 × 3.14) × 10 = |
| | 4.818 |
| | 4.818 |
| Mass of Cu, kg | 0.2611 |
| Mass of Fe, kg | (Stator_Fe(1.6047) + Rotor_Fe(0.5392)) |
| | 2.1439 |
| Mass of PM, kg | 0.2987 |
| Total mass (Eim components), | 2.7037 |
| kg | |
| Power density, kW/kg | (0.81775/2.7037) |
| | 0.3024 |

FIG. 14 illustrates a back EMF, a core loss, a loss of permanent magnet, and a rated torque of the conventional SPMSM(III).

In addition, the conventional SPMSM(III) has a maximum voltage of a back EMF of 8.01 V, a core loss of 26.55 W, a loss of permanent magnet of 6.97 W, a cogging torque of 50.68 mNm, and so on, and a rated torque thereof is 2.73 Nm.

In addition, the conventional SPMSM(III) has similar or lower results even in the material 20PN1500.

Next, as illustrated in FIG. 15, the proposed SPMSM(IV) has a double air gap type.

In addition, the proposed SPMSM(IV) includes a pair of 24 slots and a pair of 20 poles. Here, a material of the SPMSM(IV) is 35PN380.

TABLE 6

| SPMSM(IV) | |
|---|---|
| Parameter | Value |
| Stator current | 500 |
| frequency, Hz | |
| Rotor speed, rpm | 3,000 |
| Shaft torque, Nm | 6.55 |
| Electromagnetic | 7.02 |
| torque, Nm | |
| Shaft power, W | 2058.35 |
| Input electric | (2π × (3000/60) × 7.02) + (50 × 50 × (0.0033 + |
| power, W | 0.0026) × 3) |
| | 2,249.65 |
| Efficiency, % | (2058.35/2,249.64) × 100% |
| | 91.45 |
| Winding losses, W | (50 × 50 × (0.0033 + 0.0026) × 3) |
| | 44.25 |
| Core losses, W | 91.4 |
| Losses in PMs, W | 14.4 |
| Mechanical losses, W | 41.24 |
| Stator current, A rms | 50 |
| Stator current density, | (50/2)/(0.4064 × 0.4064 × 3.14) × 10 × 2 = 9.636 |
| A/mm² | 9.636 |
| Mass of Cu, kg | Outer_Stator_Cu(0.4421) + |
| | Inner_Rotor_Fe(0.2611) |
| | 0.7032 |
| Mass of Fe, kg | (Outer_Stator_Fe(1.7886) + |
| | Outer_Rotor_Fe(0.3051) + Inner Stator |
| | Fe(1.6047) + Inner_Rotor Fe(0.5392)) |
| | 2.0937 + 2.1439 = 4.2376 |
| Mass of PM, kg | Outer Stator_PM(0.1958) + |
| | Inner_Rotor_PM(0.2987) |
| | 0.4945 |
| Total mass (EIm | 5.4353 |
| components), kg | |
| Power density, kW/kg | (2.05835/5.4353) |
| | 0.3787 |

As illustrated in FIG. 16, the SPMSM(IV) proposed by the present disclosure has a maximum voltage of 20 V, a cogging torque of 102.37 mNm which is reduced by 29.7% when compared with the conventional SPMSM(I), a core loss of 91.4 W, and a loss of permanent magnet of 14.4 W.

In addition, the SPMSM(IV) proposed by the present disclosure has a rated torque of 7.02 Nm, which is increased by 37% when compared with the conventional SPMSM.

In addition, as illustrated in FIG. 17, the proposed SPMSM(V) has a double air gap type.

In addition, the proposed SPMSM(V) has a pair of 24 slots and a pair of 20 poles.

Here, a material of the SPMSM(V) is 20PN1500.

TABLE 7

| SPMSM(V) | |
|---|---|
| Parameter | Value |
| Stator current | 500 |
| frequency, Hz | |
| Rotor speed, rpm | 3,000 |
| Shaft torque, Nm | 6.57 |
| Electromagnetic | 6.98 |
| torque, Nm | |
| Shaft power (output | 2066.24 |
| power), W | |
| Input electric | (2π × (3000/60) × 6.98) + (50 × 50 × (0.0033 + |
| power, W | 0.0026) × 3) |
| | 2237.08 |
| Efficiency, % | (2066.24/2192.83) × 100% |
| | 94.23 |
| Winding losses, W | (50 × 50 × (0.0033 + 0.0026) × 3) |
| | 44.25 |
| Core losses, W | 67.8 |
| Losses in PMs, W | 17.78 |
| Mechanical losses, W | 41.01 |
| Stator current, A rms | 50 |
| Stator current density, | (50/2)/(0.4064 × 0.4064 × 3.14) × 10 × 2 = 9.636 |
| A/mm² | 9.636 |
| Mass of Cu, kg | Outer_Stator_Cu(0.4421) + |
| | Inner_Rotor_Fe(0.2611) |
| | 0.7032 |
| Mass of Fe, kg | (Outer_Stator_Fe(1.7886) + |
| | Outer_Rotor_Fe(0.3051) + |
| | Inner Stator Fe(1.6047) + |
| | Inner_Rotor Fe(0.5392)) |
| | 2.0937 + 2.1439 = 4.2376 |
| Mass of PM, kg | Outer_Stator PM(0.1958) + |
| | Inner_Rotor_PM(0.2987) |
| | 0.4945 |
| Total mass (EIm | 5.4353 |
| components), kg | |
| Power density, kW/kg | (2.06624/5.4353) |
| | 0.3801 |

As illustrated in FIG. 18, the SPMSM(V) proposed by the present disclosure has a maximum voltage of 20.32 V, a cogging torque of 93.4 mNm which is reduced by 35.9% when compared with the conventional SPMSM(I), a core loss of 67.8 W, and a loss of permanent magnet of 17.78 W.

In addition, the SPMSM(V) proposed by the present disclosure has a rated torque of 6.98 Nm, which is increased by 36.67% when compared with the conventional SPMSM.

### CONCLUSION

The conventional SPMSM has a low core loss, a low loss of permanent magnet, a low mechanical loss, and so on, and also has a low power density and a low torque.

Meanwhile, when the material 35PN380, which is the same material as the conventional SPMSM, is used, the proposed motor has a large core loss and an increased loss of permanent magnet due to a double stator structure, but efficiency similar to the conventional SPMSM is obtained while obtaining a high power density.

In addition, when 20PN1500 is used to reduce a core loss, the core loss is reduced, and a loss of permanent magnet is increased, but efficiency is increased by 2.23% and a power density increased by 22.23% when compared with the conventional SPMSM.

FIG. 19 is an exemplary cross-sectional view illustrating a double air gap SPMSM with two controllers according to an embodiment of the present disclosure, FIG. 20 is an enlarged view of a portion “Q” of FIG. 19, FIG. 21 is an exemplary longitudinal sectional view illustrating the double air gap SPMSM with two controllers, according to an embodiment of the present disclosure, and FIG. 22 is a diagram illustrating a magnetic flux direction illustrating the double air gap SPMSM with two controllers, according to an embodiment of the present disclosure.

In addition, FIG. 23 is an exemplary view illustrating a winding direction for a phase for an A phase of three phases for explaining the double air gap SPMSM with two controllers, according to an embodiment of the present disclosure, FIGS. 24 and 25 are circuit diagrams illustrating the double air gap SPMSM with two controllers, according to an embodiment of the present disclosure, and FIG. 26 is an exemplary view illustrating a partition wall portion of the double air gap SPMSM with two controllers, according to an embodiment of the present disclosure.

Meanwhile, the drawings may be exaggerated as illustrated in FIG. 21 for the sake of easy understanding.

As described above, the present disclosure is proposed as follows based on the above-described experimental results.

As illustrated in FIG. 19, a double air gap SPMSM 100 with two controllers according to an embodiment of the present disclosure includes a first stator 110, a first rotor 120, and a first permanent magnet 130, a second rotor 140, a second permanent magnet 150, a second stator 160, a circular plate member 170, a partition wall portion 180, a sleeve portion 190, a first controller 210, and a second controller 220.

As illustrated in FIGS. 19 and 20, the first stator 110 includes first protrusions 110p formed on a first inner circumferential surface 110s.

Here, the first protrusions 110p each have a T shape and are formed to be spaced apart at regular intervals on the first inner circumferential surface 110s.

In addition, in the first rotor 120, a first outer circumferential surface 120s is formed to face the first inner circumferential surface 110s.

Meanwhile, the first rotor 120 is a non-oriented electrical steel sheet manufactured by stacking multiple silicon steel sheets or manufactured by a company (POSCO), such as 35PN380, and has a standard dimension, a magnetic property, and so on with a thickness of 0.35±0.05 mm, a density of 7.65±0.1 kg/cm², a core loss of 3.80 W/kg or less, a magnetic flux density of 1.62 or more, and a conductor-occupying ratio of 95% or more.

In addition, a plurality of first permanent magnets 130 are arranged on the first outer circumferential surface 120s.

In particular, the first permanent magnets 130 include N-poles (blue) and S-poles (red) alternately arranged at equal intervals on the first outer circumferential surface 120s.

In addition, the second rotor 140 is integrally connected to the first rotor 120 while corresponding inward, to form a second inner circumferential surface 140s.

Meanwhile, the second rotor 240 is a non-oriented electrical steel sheet manufactured by stacking multiple silicon steel sheets or manufactured by a company (POSCO), such as 35PN380, and has a standard dimension, a magnetic property, and so on, with a thickness of 0.35±0.05 mm, a density of 7.65±0.1 kg/cm², a core loss of 3.80 W/kg or less, a magnetic flux density of 1.62 or more, and a conductor-occupying ratio of 95% or more.

In addition, a plurality of second permanent magnets 150 are arranged on the second inner circumferential surface 140s.

In particular, the second permanent magnets 150 include N-poles (blue) and S-poles (red) alternately arranged at equal intervals on the second inner circumferential surface 140s, and are arranged in an opposite polarity to the first permanent magnets 130.

In addition, the number of the second permanent magnets 150 is the same as the number of the first permanent magnets 130 and is less than the number of the first protrusions 110p or second protrusions 160p.

In addition, the number of poles proposed by the present disclosure is the number of first permanent magnets 130 or second permanent magnets 150.

In addition, the second stator 160 includes the second protrusions 160p formed on the second outer circumferential surface 160s facing the second inner circumferential surface 140s.

Here, the second protrusions 160p each have a T shape and are spaced apart at regular intervals on the second outer circumferential surface 160s.

In addition, the number of second protrusions 160p is the same as the number of first protrusions 110p.

Meanwhile, although the present disclosure is configured to include 24 first protrusions 110p and 20 first permanent magnets 120, the number of first protrusions 110p and the number of first permanent magnets 120 may be changed as necessary.

As illustrated in FIG. 20, a first air gap portion t01 has a predetermined air gap between the first stator 110 and the first rotor 120, and the air gap has a size of 0.8±0.1 mm.

In addition, a second air gap portion t02 has a predetermined air gap between the second stator 160 and the second rotor 140 and the air gap has a size of 0.8±0.1 mm.

In addition, the first and second rotors 120 and 140 according to another embodiment of the present disclosure are electrical steel sheets having a thickness of 0.20±0.05 mm, and are formed of a material having a density of 7.65±0.1 kg/cm², a core loss of 15.0 W/kg or less, a magnetic flux density of 1.62 or more, and a conductor-occupying ratio of 93% or more.

That is, the first and second rotors 120 and 140 are non-oriented electrical steel sheets manufactured by a company (POSCO), such as 20PN1500, and has a standard dimension, a magnetic property, and so on with a thickness of 0.20±0.05 mm, a density of 7.65±0.1 kg/cm², a core loss of 15.0 W/kg or less, a magnetic flux density of 1.62 or more, and a conductor-occupying ratio of 93% or more.

As illustrated in FIG. 21, the first and second rotors 120 and 140 rotate while being fixed to the circular plate member 170 having a rotation shaft 170r formed on one side thereof.

That is, in the present disclosure, the first and second rotors 120 and 140 are rotated by currents applied to winding wires 110w and 160w of the first and second stators 110 and 160, and the rotating force thereof is transmitted to the circular plate member 170, and thereby the circular plate member 170 rotates.

In particular, as illustrated in FIG. 22, the partition wall portion 180 according to the embodiment of the present disclosure is formed at a boundary between the first and second rotors 120 and 140, a magnetic flux generated from the first and second permanent magnets 130 and 150 is blocked to prevent mutual collision, and thus, performance such as a power density is increased.

At this time, the partition wall portion 180 is formed of a non-magnetic material such as stainless to prevent a magnetic flux of the first permanent magnet 130 from invading the second rotor 140 and to prevent a magnetic flux of the second permanent magnet 150 from invading the first rotor 120.

As illustrated in FIG. 21 and FIGS. 23 to 25, the first and second controllers 210 and 220 proposed by the present disclosure are further provided.

In addition, the first controller 210 is connected to the first winding wire 110w, and the second controller 220 is connected to the second winding wire 160w.

Here, FIG. 23 schematically illustrates a winding flux when an A phase is used among three phases, and circuit diagrams thereof are illustrated in FIGS. 24 and 25.

Conventionally, one controller controls the entire current flow, and thus, there is a problem in that a motor cannot operate completely when a part of the motor is damaged.

Accordingly, the present disclosure includes two controllers, and the first controller 210 controls the first winding wire 110w wound around the first protrusion 110p, and the second controller 220 controls the second winding wire 160w wound around the protrusion 160p, and thus, even when any one of the first and second controllers 210 and 220 fails, the other of the first and second controllers 210 and 220 may control rotations of the first and second rotors 120 and 140 which are integrally formed.

As illustrated in FIG. 26, the present disclosure further includes the sleeve portion 190, thereby solving a problem that the first permanent magnet 130 in an outer edge is easily detached by a centrifugal force or is damaged by bumping during rotation, or a problem that the second permanent magnet 150 in an inner edge is out of rotation due to a centripetal force or is damaged by colliding with surroundings.

That is, the sleeve portion 190 proposed by the present disclosure includes a first sleeve portion 190a and a second sleeve portion 190b.

In addition, the first sleeve portion 190a may have a hollow cylindrical shape with open front and rear portions, may be formed of a metal material having a predetermined thickness for protecting the first permanent magnet 130 while wrapping around an outer edge of the first permanent magnet 130 to prevent the first permanent magnet 130 from being detached, and may have a predetermined tensile force to firmly cover the first permanent magnet 130.

In addition, the second sleeve portion 190b may have a hollow cylindrical shape with open front and rear portions, may be formed of a metal material having a predetermined thickness for protecting the second permanent magnet 150 while wrapping around an outer edge of the first permanent magnet 130 to support the first permanent magnet 130 to prevent the first permanent magnet 130 from being detached, and may have a predetermined tensile force to firmly cover the first permanent magnet 130.

In summary, a double air gap surface permanent magnet synchronous motor 100 with two controllers according to an embodiment of the present disclosure, includes a first stator 110 including first protrusions 110p formed on a first inner circumferential surface 110s, a first rotor 120 including a first outer circumferential surface 120s facing the first inner circumferential surface 110s, first permanent magnets 130 arranged on the first outer circumferential surface 120s, a second rotor 140 integrally connected to the first rotor 120 to correspond to an inside of the first rotor 120 and including a second inner circumferential surface 140s, second permanent magnets 150 arranged on the second inner circumferential surface 140s, a second stator 160 including second protrusions 160p formed on a second outer circumferential surface 160s formed to face the second inner circumferential surface 140s, and a partition wall portion 180 formed at a boundary between the first rotor 120 and the second rotor 140.

In addition, the first controller 210 for electrically controlling the first winding wire 110w wound around the first protrusion 110p, and the second controller 220 for electrically controlling the second winding wire 160w wound around the second protrusion 160p are further provided to allow the other of the first and second controllers 210 and 220 which are formed integrally with each other to control rotations of the first and second rotors 120 and 140 when any one of the first and second controllers 210 and 220 fails.

In addition, the first air gap portion t01 has a predetermined space between the first stator 110 and the first rotor 120, and the second air gap portion t02 has a predetermined space between the second stator 160 and the second rotor 140.

In addition, the first permanent magnets 130 include N-poles and S-poles alternately arranged at equal intervals on the first outer circumferential surface 120s, and the second permanent magnets 150 include N-poles and S-poles alternately arranged at equal intervals on the second inner circumferential surface 140s and are arranged in opposite polarity to the first permanent magnets 130.

In addition, the number of first protrusions 110p is the same as the number of second protrusions 160p, and the number of first permanent magnets 130 is the same as the number of second permanent magnets 150 and is less than the number of first protrusions 110p.

In addition, the first protrusions 110p each have a T shape and are spaced apart from each other at regular intervals on the first inner circumferential surface 110s, and the second protrusions 160p each have a T shape and are spaced apart from each other at regular intervals on the second outer circumferential surface 160s.

In addition, there are 24 first protrusions 110p and 20 first permanent magnets 120.

In addition, the first and second rotors 120 and 140 are electrical steel sheets having a thickness of 0.20±0.05 mm, and has a density of 7.65±0.1 kg/cm², a core loss of 15.0 W/kg or less, a magnetic flux density of 1.62 or more, and a conductor-occupying ratio of 93% or more.

In addition, the first and second rotors 120 and 140 rotate while being fixed to the circular plate member 170 having the rotation shaft 170r formed on one side thereof.

In addition, the partition wall portion 180 blocks mutual magnetic fluxes generated from the first and second permanent magnets 130 and 150.

In addition, the partition wall portion 180 is formed of a non-magnetic material.

In addition, the first sleeve portion 190a having a hollow cylindrical shape with open front and rear portions and having a predetermined thickness for protecting the first permanent magnet 130 while wrapping around an outer edge of the first permanent magnet 130 to prevent the first permanent magnet 130 from being detached, and the second sleeve portion 190b having a hollow cylindrical shape with open front and rear portions and having a predetermined thickness for protecting the second permanent magnet 150 while wrapping around an inner edge of the second permanent magnet 150 to prevent the second permanent magnet 150 from being detached.

In addition, the first and second sleeve portions 190a and 190b are formed of metal.

Accordingly, the double air gap surface permanent magnet synchronous motor 100 with two controllers according to an embodiment of the present disclosure may obtain the following effects.

According to the present disclosure, there is an advantage in that a high power density and a high torque are obtained because a double air gap structure is provided.

In addition, there is an advantage in that a cogging torque may be reduced more than in the past by the double air gap structure.

In addition, there is an advantage of increasing efficiency by improving a material of the double air gap structure under the same conditions.

In addition, the partition wall portion 180 blocks mutual magnetic fluxes generated from the first and second permanent magnets, and thus, a high torque is generated.

In addition, there is an advantage in that two controllers are provided and even when one of the two controllers fails, the other controller may perform control.

In addition, there is an advantage of preventing the first and second permanent magnets 130 and 150 from being detached by using the cylindrical sleeve portion 190.

The above description is merely illustrative of the technical idea of the present disclosure, and those skilled in the technical field to which the present disclosure belongs may make various modifications, changes, and substitutions within the scope not departing from the essential characteristics of the present disclosure.

Accordingly, the embodiments disclosed in the present disclosure and the accompanying drawings are not intended to limit the technical idea of the present disclosure but to describe the technical idea, and the scope of the technical idea of the present disclosure is not limited by the embodiments and the accompanying drawings.

The scope of protection of the present disclosure should be interpreted by the following claims, and all technical ideas within the scope equivalent thereto should be construed as being included in the scope of the present disclosure.

### REFERENCE NUMERALS

100: motor proposed by the present disclosure
110: first stator
120: first rotor
130: first permanent magnet
140: second rotor
150: second permanent magnet
160: second stator
170: circular plate member
180: partitioning wall portion
190: sleeve portion
210: first controller
220: second controller

What is claimed is:

1. A double air gap surface permanent magnet synchronous motor with two controllers, comprising:
a first stator configured to include first protrusions formed on a first inner circumferential surface;
a first rotor configured to include a first outer circumferential surface facing the first inner circumferential surface;
first permanent magnets arranged on the first outer circumferential surface;
a second rotor integrally connected to the first rotor to correspond to an inside of the first rotor and configured to include a second inner circumferential surface;
second permanent magnets arranged on the second inner circumferential surface;
a second stator configured to include second protrusions formed on a second outer circumferential surface formed to face the second inner circumferential surface;
a partition wall portion formed at a boundary between the first rotor and the second rotor;
a first controller for controlling a first winding wire wound around the first protrusions; and
a second controller for controlling a second winding wire wound around the second protrusions,
wherein a first air gap portion of a predetermined space is formed between the first stator and the first rotor,
wherein a second air gap portion of a predetermined space is formed between the second stator and the second rotor,
wherein the first permanent magnets include N-poles and S-poles alternately arranged at equal intervals on the first outer circumferential surface,
wherein the second permanent magnets include N-poles and S-poles alternately arranged at equal intervals on the second inner circumferential surface and are arranged in an opposite polarity to the first permanent magnets,
wherein a number of the first protrusions is the same as a number of the second protrusions, the number of the first permanent magnets is the same as the number of the second permanent magnets and is less than the number of the first protrusions, and
wherein, when any one of the first controller and the second controller fails, the other controller controls rotations of the first rotor and the second rotor integrally formed with each other.

2. The double air gap surface permanent magnet synchronous motor with two controllers of claim 1,
wherein the partition wall portion blocks mutual magnetic fluxes generated from the first permanent magnets and the second permanent magnets.

3. The double air gap surface permanent magnet synchronous motor with two controllers of claim 1,
wherein the partition wall portion is formed of a non-magnetic material.

4. The double air gap surface permanent magnet synchronous motor with two controllers of claim 1,
wherein the first rotor and the second rotor are fixed to a circular plate member having a rotation shaft formed on one side thereof to rotate.
